(19) United States
(12) Patent Application Publication
(10) Pub. No.: US 2007/0085479 A1
(43) Pub. Date: Apr. 19, 2007

(54) Plasma display panel (PDP) and its method of manufacture

(76) Inventors: Yong-Shik Hwang, Suwon-si (KR); Jeong-Nam Kim, Suwon-si (KR); Hyea-Weon Shin, Suwon-si (KR); Hak-Cheol Yang, Suwon-si (KR); Tae-Seung Cho, Suwon-si (KR)

Correspondence Address: Robert E. Bushnell, Suite 300, 1522 K Street, N.W., Washington, DC, 20005, US

(21) Appl. No.: 11/544,758

(22) Filed: Oct. 10, 2006

(30) Foreign Application Priority Data
Oct. 13, 2005 (KR) 10-2005-0096511

(51) Int. Cl. H01J 17/49

(52) U.S. Cl. 313/582; 313/583

(57) ABSTRACT

A Plasma Display Panel (PDP) that has a structure of a discharge cell realizing high definition and high efficiency and its method of manufacture includes: forming first electrodes on a substrate; forming a first dielectric layer on the substrate to cover the first electrodes; forming a second dielectric layer to cover the first dielectric layer; coating a resist on the second dielectric layer; patterning the resist; etching the second dielectric layer with the patterned resist as a protective layer to form recessed areas for electrode formation and recessed areas for discharge space formation; filling the recessed areas for electrode formation with an electrode paste to form second electrodes and third electrodes; and forming a third dielectric layer on a portion of the second dielectric layer to cover the recessed areas for electrode formation filled with the electrode paste.

### CLAIM OF PRIORITY

This application makes reference to, incorporates the same herein, and claims all benefits accruing under 35 U.S.C. §119 from an application for PLASMA DISPLAY PANEL AND METHOD OF MANUFACTURING THE SAME, earlier filed in the Korean Intellectual Property Office on the 13^{th} of Oct. 2005 and there duly assigned Serial No. 10-2005-0096511.

### BACKGROUND OF THE INVENTION

1. Field of the Invention

The present invention relates to a Plasma Display Panel (PDP) and its method of manufacture. More particularly, the present invention relates to a PDP having a discharge cell structure realizing high definition and high efficiency and to its method of manufacture.

2. Description of the Related Art

A Plasma Display Panel (PDP) is generally a display in which vacuum ultraviolet (VUV) rays from a plasma generated by a gas discharge excite phosphors to emit red, green, and blue visible light for producing an image. Such a PDP can achieve a large screen display with a size over 60 inches (˜152.4 cm) while keeping its thickness within 10 cm. As an emissive display like a Cathode Ray Tube (CRT), the PDP has features of excellent color reproduction and no distortion along its viewing angle. Compared to a Liquid Crystal Display (LCD), the PDP has an advantage of a simple manufacturing process resulting in a good productivity and low cost. As a result, the PDP has emerged as a promising flat display for home and industry.

The structure of the PDP has been developed over a long period since 1970s, and its well-known structure at present is a three-electrode surface discharge structure. The structure of the three-electrode surface discharge PDP includes a first substrate having two electrodes positioned on the same surface, a second substrate, spaced apart from the first substrate and having address electrodes formed thereon in the direction crossing the electrodes on the first substrate, and a discharge gas contained within the space sealed by the first and the second substrates. Generally, the turn-on/off of a discharge cell of the PDP is determined by an address discharge occurring between the address electrode and the separately controlled scan electrode facing the address electrode, and a sustain discharge determining luminance is effected by a two-electrode group arranged on the same surface.

The PDP introduced recently in the market features XGA (1024×768) resolution in a 42 inch panel, and there is, however, an increasing need for a display with a higher resolution to full-high definition (HD). In order to produce an image with the full-HD (1920×1080) resolution on the PDP, it is necessary to reduce the size of the discharge cells of the PDP, i.e., to realize the high-definition.

In a PDP with the conventional three-electrode surface discharge structure, a decrease in the size of the discharge cell implies a decrease in both the length and the area of the electrode. That may consequently result in an increase in the firing voltage as well as degradation in both the luminance and the efficiency of the PDP. As the PDP needs higher resolution, there is, therefore, a growing need for a PDP having a different structure from the conventional three-electrode surface discharge structure in which address and sustain discharges respectively occur as face and surface discharges.

### SUMMARY OF THE INVENTION

The present invention provides a Plasma Display Panel (PDP) having a structure of a discharge cell to induce a face discharge for the sustain discharge between a pair of the display electrodes in order to solve the shortcoming in discharging inside a small discharge cell.

The present invention also provides a method of manufacturing a Plasma Display Panel (PDP) having a structure of a discharge cell to induce a face discharge for the sustain discharge, the discharge cell formed by etching for a smooth discharge surface and a reduction in manufacturing time.

According to one embodiment of the present invention, a method of manufacturing a Plasma Display Panel (PDP) includes: forming first electrodes on a substrate; forming a first dielectric layer on the substrate to cover the first electrodes; forming a second dielectric layer to cover the first dielectric layer; coating a resist on the second dielectric layer; patterning the resist; etching the second dielectric layer with the patterned resist as a protective layer to form recessed areas for electrode formation and recessed areas for discharge space formation; filling the recessed areas for electrode formation with an electrode paste to form second electrodes and third electrodes; and forming a third dielectric layer on a portion of the second dielectric layer to cover the recessed areas for electrode formation filled with the electrode paste.

The first electrodes preferably each include a bus electrode formed to extend in a first direction and a protrusion electrode extending from the bus electrode in a second direction crossing the first direction.

The second dielectric layer is preferably formed to be thicker than the first dielectric layer.

The first dielectric layer is preferably formed of an etching-resistant dielectric material.

The second dielectric layer is preferably formed of an etchable dielectric material.

The recessed areas for electrode formation are preferably formed to extend in a direction crossing an extending direction of the first electrodes.

Forming the recessed areas for electrode formation and the recessed areas for discharge space formation preferably includes: coating a resist on the second dielectric layer; patterning the resist through exposure and development; and spraying an etchant on the resist and on the second exposed dielectric layer to etch the second dielectric layer.

Coating the resist on the second dielectric layer preferably includes coating either a photoresist or a dry film resist.

The recessed areas for discharge space formation are preferably formed wider than the recessed areas for electrode formation. The recessed areas for discharge space formation are preferably formed deeper than the recessed areas for electrode formation. The recessed areas for electrode formation are preferably formed as a continuous groove. The recessed areas for discharge space formation are preferably formed as a continuous groove. The recessed areas for discharge space formation are preferably alternatively formed discontinuously to be a plurality of independent discharge spaces arranged in parallel.

Filling the recessed areas with the electrode paste preferably includes filling the recessed areas for electrode formation with a silver paste. Filling the recessed areas for electrode formation with the electrode paste preferably includes filling the recessed areas for electrode formation with a dispenser.

The electrode paste to fill the recessed areas for electrode formation is preferably formed in the recessed areas for electrode formation by a pattern printing method.

The third dielectric layer is preferably formed by a pattern printing method.

The method preferably further includes firing the third dielectric layer after forming the third dielectric layer.

According to another embodiment of the present invention, a method of manufacturing a Plasma Display Panel (PDP) includes: forming first electrodes on a first substrate; forming a first dielectric layer on the first substrate to cover the first electrodes; forming a second dielectric layer on a second substrate; coating a resist on the second dielectric layer; patterning the resist; etching the second dielectric layer with the patterned resist as a protective layer to form recessed areas for electrode formation and recessed areas for discharge space formation; filling the recessed areas for electrode formation with an electrode paste to form second electrodes and third electrodes; and bonding the first substrate to the second substrate.

The recessed areas for electrode formation are preferably formed to extend in a direction crossing an extending direction of the first electrodes.

The second dielectric layer is preferably formed to be thicker than the first dielectric layer.

Forming the recessed areas for electrode formation and the recessed areas for discharge space formation preferably includes: coating a resist on the second dielectric layer; patterning the resist through exposure and development; and spraying an etchant on the resist and the exposed second dielectric layer to etch the second dielectric layer.

Coating the resist on the second dielectric layer preferably includes coating either a photoresist or a dry film resist.

The recessed areas for discharge space formation are preferably formed wider than the recessed areas for electrode formation. The recessed areas for discharge space formation are preferably formed depth than the recessed areas for electrode formation. The recessed areas for electrode formation are preferably formed as a continuous groove. The recessed areas for discharge space formation are preferably formed as a continuous groove. The recessed areas for discharge space formation are preferably alternatively formed discontinuously to be a plurality of independent discharge spaces arranged in parallel.

Filling the recessed areas with the electrode paste preferably includes filling the recessed areas for electrode formation with a silver paste. Filling the recessed areas for electrode formation with the electrode paste preferably includes filling the recessed areas for electrode formation with a dispenser.

The electrode paste to fill the recessed areas for electrode formation is preferably formed in the recessed areas for electrode formation by a pattern printing method.

According to still another embodiment of the present invention, a Plasma Display Panel (PDP) includes: a first substrate and a second substrate, the first and second substrates arranged to face each other; a plurality of discharge cells defined in a space between the first and second substrates; first electrodes arranged parallel to each other on the first substrate in a first direction; second electrodes and third electrodes arranged on the first substrate in a second direction crossing the first direction, the second and third electrodes respectively corresponding to each of the discharge cells and spaced apart from the first electrodes; a phosphor layer arranged inside each of the discharge cells; and dielectric layers surrounding the second and third electrodes, the second and third electrodes protruding from the first substrate in a third direction toward the second substrate; and the second electrodes and the third electrodes are arranged to face each other with a discharge space therebetween, each discharge space having a maximum inner width at a position where the respective second electrode faces the respective third electrode.

The PDP preferably further includes curved discharge surfaces, the discharge surfaces on which the dielectric layer surrounding the second electrodes and the third electrodes being exposed to the discharge space.

The PDP preferably further includes a dielectric layer arranged to cover the first electrodes and to separate the first electrodes from the second electrodes and the third electrodes, the dielectric layer including an etching-resistant dielectric material.

The PDP preferably further includes a dielectric layer surrounding the second electrodes and the third electrodes, the dielectric layer including an etchable dielectric material.

The second electrodes and the third electrodes are preferably arranged over boundaries of the discharge cells to pass along the boundary thereof and alternately positioned.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is partial perspective view of a disassembled Plasma Display Panel (PDP) according to a first embodiment of the present invention.

FIG. 2 is a plan view of the electrodes and the structure of the discharge cell of the PDP according to the first embodiment of the present invention.

FIG. 3 is a plan view of the electrodes and the structure of the discharge cell of the PDP according to the modified embodiment of the first embodiment of the present invention.

FIG. 4 is partial sectional view of the assembled PDP taken along the section line IV-IV of FIG. 1.

FIG. 5 is a flowchart of a method of manufacturing a PDP according to the first embodiment of the present invention.

FIGS. 6A to 6F are cross-sectional views of the PDP according to the first embodiment of the present invention during the processes for its manufacture.

FIG. 7 is a plan view of an exemplary arrangement of the recessed areas for electrode formation and the recessed areas for discharge space formation, both formed by etching a second dielectric layer in the method of manufacturing a PDP according to the first embodiment of the present invention.

FIG. 8 is a plan view of another exemplary arrangement of the recessed areas for electrode formation and the recessed areas for discharge space formation, both formed by etching a second dielectric layer in the method of manufacturing a PDP according to the first embodiment of the present invention.

FIG. 9 is a flowchart of a method of manufacturing a PDP according to a second embodiment of the present invention.

FIGS. 10A to 10E are cross-sectional views of the PDP according to the second embodiment of the present invention during the processes for its manufacture.

### DETAILED DESCRIPTION OF THE INVENTION

Hereinafter, the embodiments of the present invention are described in detail with reference to appended drawings. However, the present invention can have different forms and is not limited to these embodiments.

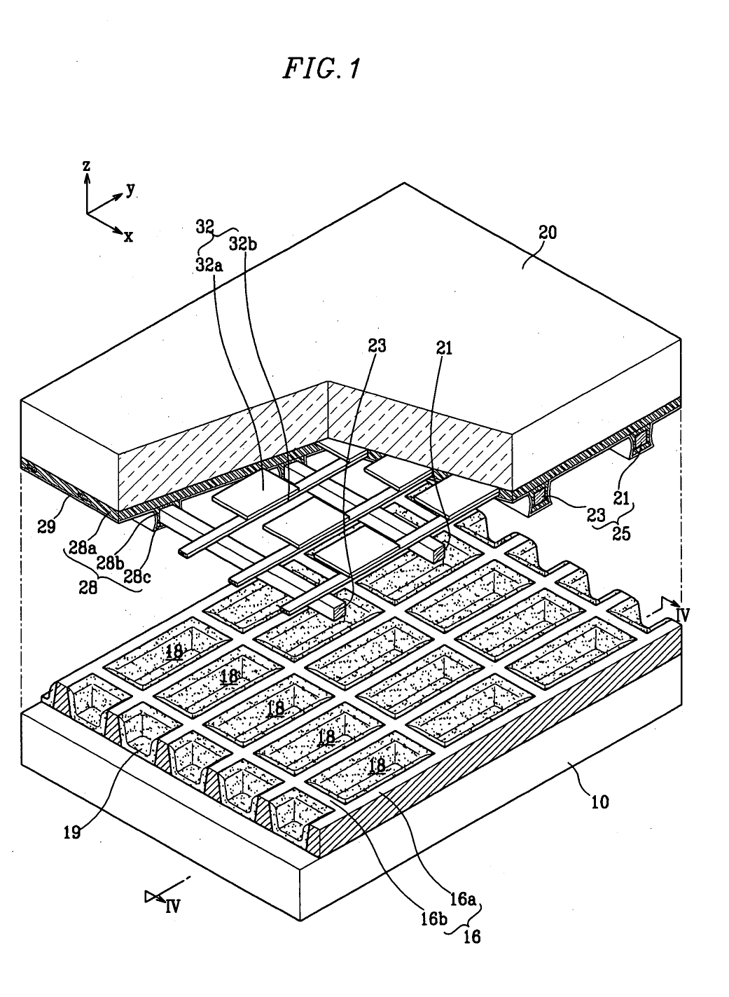

In a first embodiment of the present invention, as shown in FIG. 1, a Plasma Display Panel (PDP) includes a rear substrate 10 and a front substrate 20, both placed parallel to each other and spaced apart from each other. Barrier ribs 16 are formed to define a plurality of discharge cells 18 in the space between the rear substrate 10 and the front substrate 20. A phosphor layer 19 absorbing ultraviolet rays so as to emit visible light is formed on the bottom surface of the discharge cells 18 and the surfaces of the barrier ribs 16 defining the discharge cells 18, which are filled with a discharge gas (for example, a gas mixture of xenon and neon).

Address electrodes 32 are formed to be parallel to each other in a direction (y-direction in the drawing) on the inner surface of the front substrate 20, the inner surface facing the rear substrate 10. A dielectric layer 28 is formed over the entire inner surface of the front substrate 20 and covering the address electrodes 32. The address electrodes 32 are formed to be parallel to neighboring address electrodes 32 and spaced apart by a predetermined distance.

Display electrodes 25 that are electrically separated from the address electrodes 32 by the dielectric layer 28 are formed over the address electrodes 32.

The barrier ribs 16 are formed on the rear substrate 10. The barrier ribs 16 in the present embodiment include first barrier rib members 16a that are formed extending in the extending direction of the address electrodes 32 and second barrier rib members 16b which are formed extending in the direction crossing the first barrier rib members 16a so as to define each of the discharge cells 18 as an independent discharge space.

Such a structure of the barrier ribs does not limit the scope of the present invention. Not only a stripe structure of the barrier ribs having barrier rib members formed only in the direction of the address electrodes, but also the various structures of the barrier ribs defining discharge cells fall in the scope of the present invention.

In another embodiment, the barrier ribs 16 can be formed on top of a dielectric layer formed on the rear substrate 10.

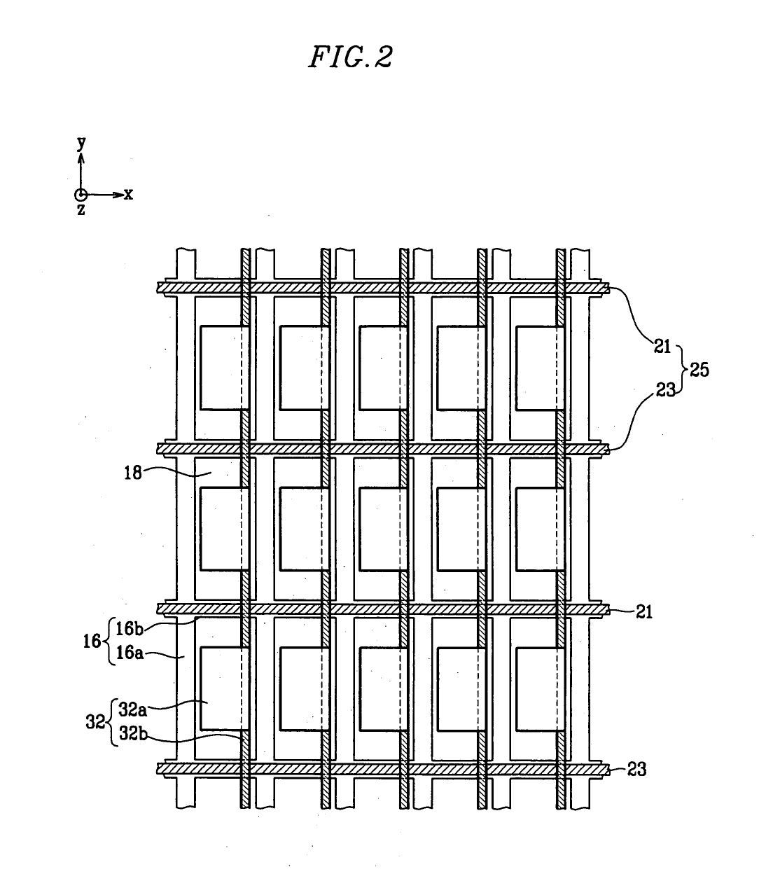

FIG. 2 is a plan view of the electrodes and the structure of the discharge cell of the PDP according to the first embodiment of the present invention.

As shown in FIG. 2, the display electrodes 25 include sustain electrodes 21 and scan electrodes 23, both electrodes corresponding to each discharge cell 18, extending in a direction (x-direction in drawing) crossing the address electrodes 32. The sustain electrode 21 serves as an electrode to supply a voltage required for discharge during the discharge sustain period, and the scan electrode 23 serves as an electrode to supply respective voltages required during the reset period, the address period and the discharge sustain period. Therefore, the scan electrodes 23 are involved with all of the reset period, the address period and the discharge sustain period, and the sustain electrodes are mainly involved with the discharge sustain period. However, the role of each electrode can be changed depending on the voltage supplied thereto, and the present invention is not limited to the aforementioned role.

The sustain electrodes 21 and the scan electrodes 23 are formed over the boundary of the discharge cells 18 and passing along the boundary thereof and are positioned alternately.

In the present embodiment, the address electrode 32 includes a bus electrode 32b, formed near one edge of the discharge cell 18, extending along the edge thereof and a protrusion electrode 32a protruding from the bus electrode 32b toward the opposing edge of the discharge cell 18.

The protrusion electrodes 32a can be transparent by being made of, for example, Indium-Tin Oxide (ITO), to obtain a high aperture ratio. Preferably, the bus electrodes 32b can be made of a metallic material to obtain a high conductance for compensating for the high resistance of the transparent electrode. In the PDP according to the present embodiment, the protrusion electrodes 32a are plain and rectangular in shape. However, the protrusion electrodes can vary in shape, taking into account the discharging characteristics inside the discharge cell 18.

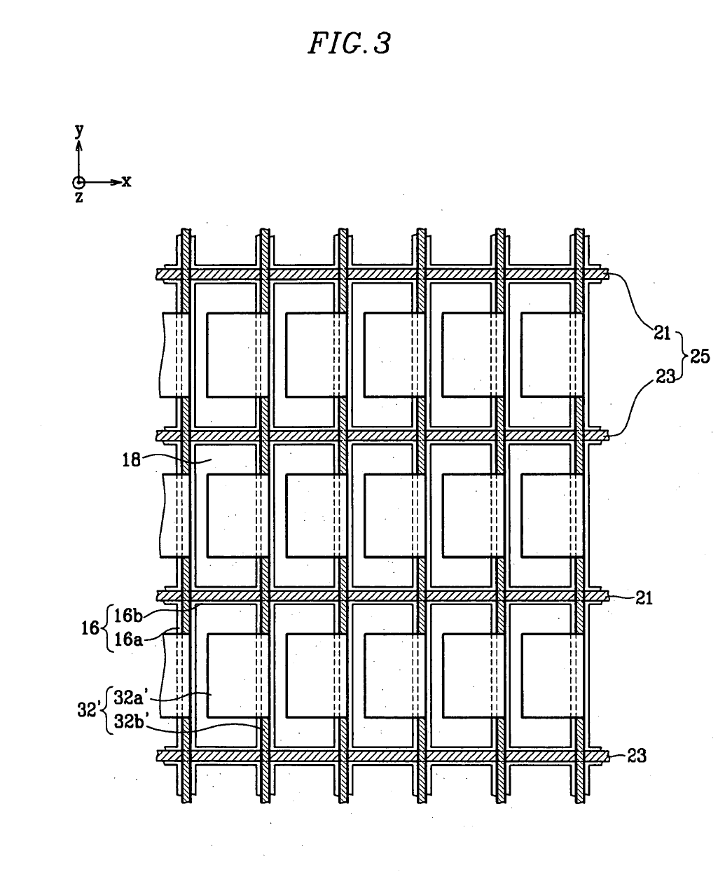

FIG. 3 is a plan view of the electrodes and the structure of the discharge cells of the PDP according to the modified embodiment of the first embodiment of the present invention.

As shown in FIG. 3, a bus electrode 32′b of an address electrode 32′ is positioned over and along the first barrier rib member 16a. A protrusion electrode 32′a is formed extending toward the center of the discharge cell 18 so as to at least partially cover the discharge cell 18.

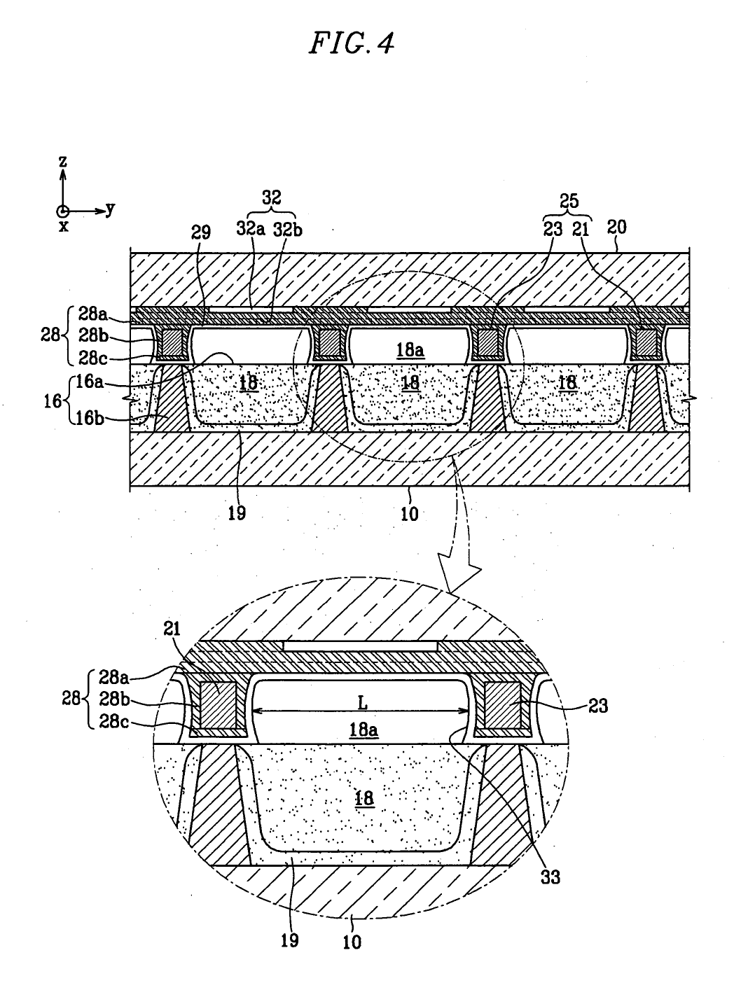

FIG. 4 is partial sectional view of the assembled PDP taken along the section line IV-IV of FIG. 1.

In the PDP according to the present embodiment, as shown in FIG. 4, both the sustain electrodes 21 and the scan electrodes 23 protrude toward the rear substrate 10 in the direction (negative z-direction in the drawing) away form the front substrate 20 so that both electrodes face each other with a space therebetween. Such a space can induce a face discharge between the sustain electrodes 21 and the scan electrodes 23 facing each other.

Also, the sustain electrodes 21 and the scan electrodes 23 can be formed such that each cross-section thereof, the cross-section perpendicular to the extending direction of both electrodes, is wider in the direction (z-direction in the drawing) perpendicular to the surface of the substrates 10 and 20 than in the direction (y-direction in the drawing) parallel to the surface of the substrates 10 and 20. In other words, the sustain electrodes 21 and the scan electrodes 23 can be formed larger in height from the front substrate 20 than in width. Therefore, a reduction in plane area of the discharge cell, the plane area projected to the substrate, required for a high-definition PDP can be compensated for by increasing heights of the sustain electrodes 21 and the scan electrodes 23.

In the present embodiment, the sustain electrodes 21 and the scan electrodes 23 are formed in a different layer from the layer where the address electrodes 32 are formed, and are electrically separated from each other. For this purpose, the dielectric layer 28 includes a first dielectric layer 28a, a second dielectric layer 28b and a third dielectric layer 28c. The first dielectric layer 28a is formed to cover the address electrodes 32 on the front substrate 20. The second dielectric layer 28b and the third dielectric layer 28c are formed over the first dielectric layer 28a so as to surround each of the sustain electrodes 21 and scan electrodes 23. The second dielectric layer 28b covers both side surfaces of each of the sustain electrodes 21 and scan electrodes 23, and the third dielectric layer 28c covers a surface of each of the sustain electrodes 21 and scan electrodes 23, the surface facing the rear substrate 10, that is, facing the barrier ribs 16.

The first dielectric layer 28a can be made of a lead (Pb) base etching-resistant dielectric material, and the second dielectric layer 28b can be made of a zinc barium (ZnBa) base etchable dielectric material. The third dielectric layer 28c can be made of a lead (Pb) or zinc barium (ZnBa) base dielectric material. The sustain electrodes 21 and the scan electrodes 23 are preferably formed as metal electrodes and can be made of silver (Ag), for example.

The first dielectric layer 28a, the second dielectric layer 28b and the third dielectric layer 28c are covered with a magnesium oxide (MgO) protective layer 29 to protect the dielectric layers from ions hitting them during the plasma discharge. Such an MgO protective layer 29 can increase discharge efficiency by a high secondary electron emission coefficient due to ion hitting.

The discharge spaces 18a defined by the first dielectric layer 28a, the second dielectric layer 28b and the third dielectric layer 28c are formed to have a maximum inner width L at a position where the sustain electrodes 21 faces the scan electrodes 23. The inner width L of the discharge spaces 18a, as shown in FIG. 4, can be measured in the direction crossing the extending direction of the sustain electrodes 21 or the scan electrodes 23. For a large inner width L of the discharge spaces 18a, the second dielectric layer 28b covering the sustain electrodes 21 or the scan electrodes 23 is formed to be relatively thin to reduce the discharge voltage because an electric field is easily concentrated when the voltage is supplied between the sustain electrodes 21 and the scan electrodes 23. Also, the increase in volume of the discharge spaces 18a increases the volume of plasma generated therein.

Furthermore, discharge surfaces 33 of the second dielectric layer 28b can be formed to be curved, the discharge surfaces 33 being exposed to the inside of the discharge spaces 18a. If the MgO protective layer 29 covers the second dielectric layer 28b, then the second dielectric layer 28b is not actually exposed to the inside of the discharge spaces 18a. However, the discharge surfaces 33 can be defined as a surface facing the inside of the discharge spaces 18a.

As explained hereinabove, the PDP according to the present embodiment has the address electrodes 32 placed on the front substrate 20 so that the discharge space defined by the barrier ribs formed on the rear substrate 10 increases in volume because all of the electrodes involved with the discharge inside the discharge cell 18 are positioned on the front substrate 20. Therefore, the luminous efficiency of the PDP is improved due to the increase in area where the phosphors are coated. In addition, with no phosphors between the electrodes and the discharge spaces, a reduction in the lifetime of the phosphors by ion sputtering due to accumulated electric charges on the phosphors can be avoided.

An address voltage can be lowered by placing the scan electrodes 23 and the address electrodes 32 close to each other, both electrodes being involved with the address discharge. Also, it is possible to obtain a long gap discharge that is well known for excellent luminous efficiency by inducing a face discharge between the sustain electrodes 21 and the scan electrodes 23. As a result, a higher luminous efficiency can be obtained, compared to a conventional surface discharge structure. Furthermore, it is possible to solve the major problems such as degradation in both the luminance and the luminous efficiency and rise in the firing voltage present in the conventional surface discharge structure having small discharge cells for high-definition.

Hereinafter, a method of manufacturing the PDP explained above is described in detail.

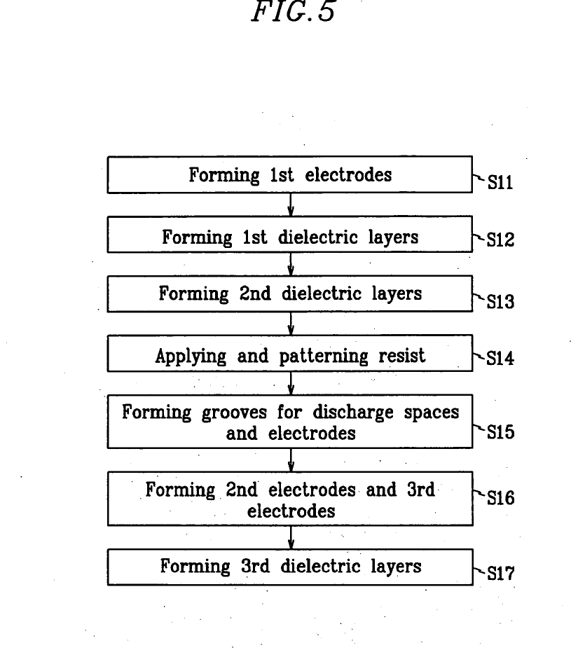

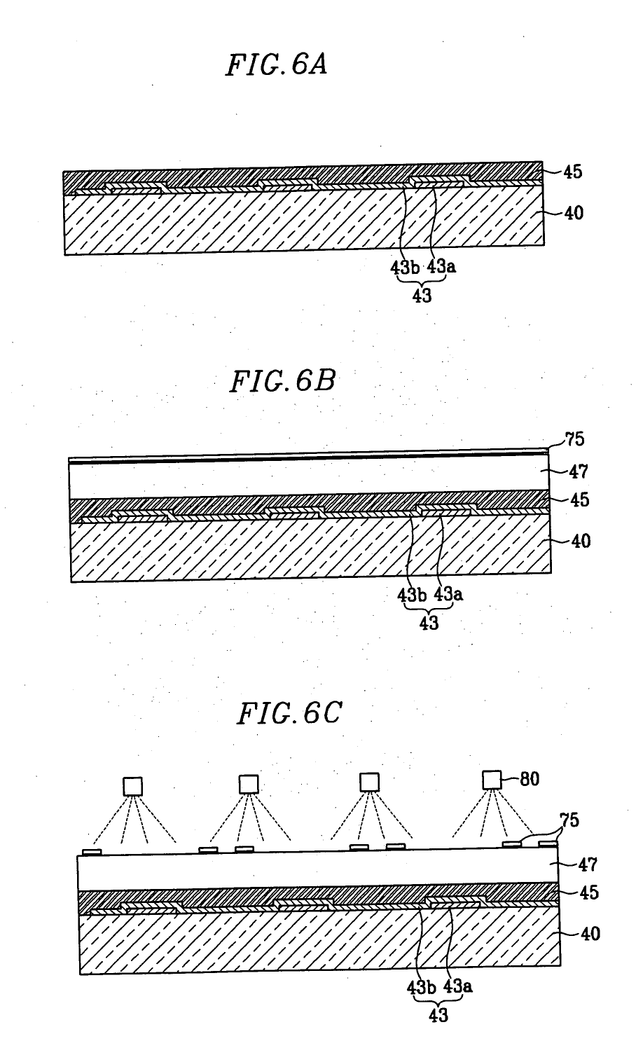

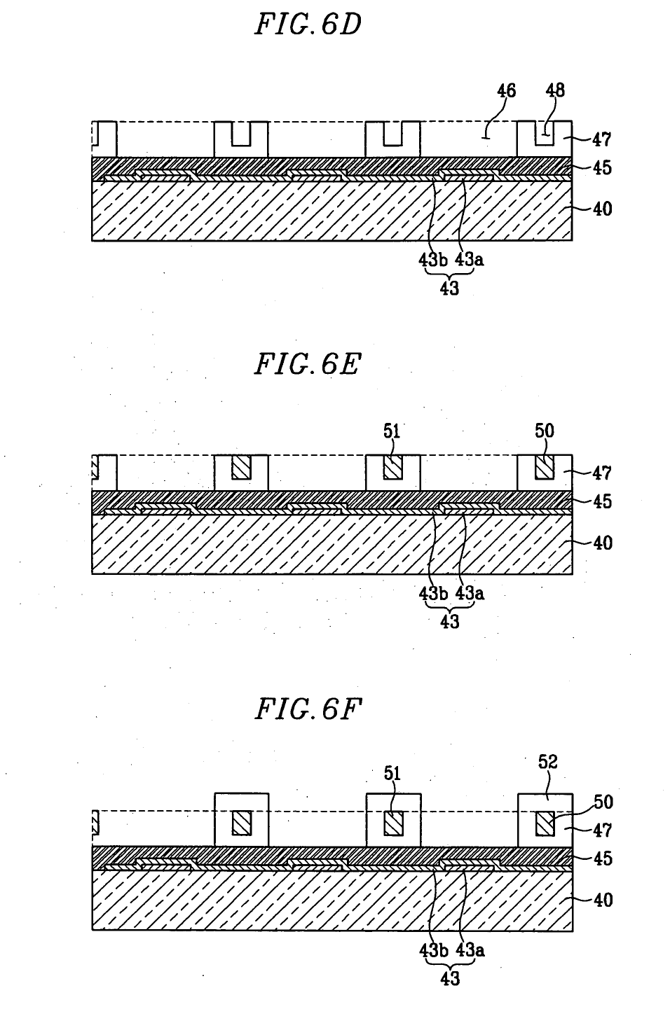

FIG. 5 is a flowchart of a method of manufacturing a PDP according to the first embodiment of the present invention, and FIGS. 6A to 6F are cross-sectional views of the PDP according to the first embodiment of the present invention during the processes for its manufacture.

First, first electrodes 43 are formed on a substrate 40 (S11)(see FIG. 6A).

Each first electrode 43 includes a bus electrode 43b extending in a first direction and protrusion electrodes 43a extending in a second direction crossing the first direction. A plurality of the bus electrodes 43b of the first electrode 43 are arranged in parallel to each other and can be made of metal. The protrusion electrodes 43a are preferably made of a transparent material, for example, Indium-Tin-Oxide (ITO).

The first electrodes 43 formed accordingly serve as address electrode for selecting a discharge cell to be turned on when an address voltage is supplied thereto during the address period.

Then, a first dielectric layer 45 is formed on the substrate 40 in order to cover the first electrodes 43 (S12) (See FIG. 6A).

The first dielectric layer 45 can be formed by drying/firing a dielectric paste that has been coated by a screen printing method. As an alternative to the screen printing method, a dielectric sheet (green sheet) can be laminated by a laminator to the front substrate 40, or a dielectric paste can be coated by a coator.

The first dielectric layer 45 can be made of a lead (Pb) base etching-resistant dielectric material.

Then, a second dielectric layer 47 is formed to cover the first dielectric layer 45 (S13) (See FIG. 6B).

The second dielectric layer 47 can be formed by drying/firing a dielectric paste that has been coated by a screen printing method. As an alternative to the screen printing method, a dielectric sheet (green sheet) can be laminated by a laminator to the first dielectric layer 45, or a dielectric paste can be coated by a coator.

The second dielectric layer 47 is formed to be thicker than the first dielectric layer 45. Since the second dielectric layer 47 is etched off to form recessed areas 48 for electrode formation and recessed areas 46 for discharge space formation, the second dielectric layer 47 is preferably formed thick enough for the space required for a discharge.

Such a second dielectric layer 47 can be made of a zinc barium (ZnBa) base etchable dielectric material.

Next, a resist 75 is coated on top of the second dielectric layer 47, and the resist 75 is patterned (S14) (See FIG. 6B).

A photoresist or dry film resist can be used for the resist 75. Depending on an etchant, either the photoresist or the dry film resist is selected. More specifically, the dry film resist is used for a solid-phase etching material, and the photoresist is used for a liquid phase etching material.

For patterning the resist 75, the resist 75 is covered by a photomask having a predetermined pattern, exposed to a light source (for example, ultraviolet rays), and then developed by a developing liquid. This process demarcates the region to be the recessed areas 48 for electrode formation and the region to be the recessed areas 46 for discharge space formation.

Next, the recessed areas 48 for electrode formation and the recessed areas 46 for discharge space formation are formed together by etching the second dielectric layer 47 with the patterned resist 75 as a protective layer (S15) (See FIGS. 6C and 6D).

More specifically, an etchant is sprayed through a nozzle 80 on top of the patterned resist 75. The exposed area of the second dielectric layer 47 through the patterned resist 75 is etched thereby to form the recessed areas, and unexposed area remains intact to form the dielectric layer protecting a second electrode 50 and a third electrode 51.

The recessed areas 48 for electrode formation are formed extending in the direction crossing the extending direction of the first electrode 43, and are formed as a continuous groove.

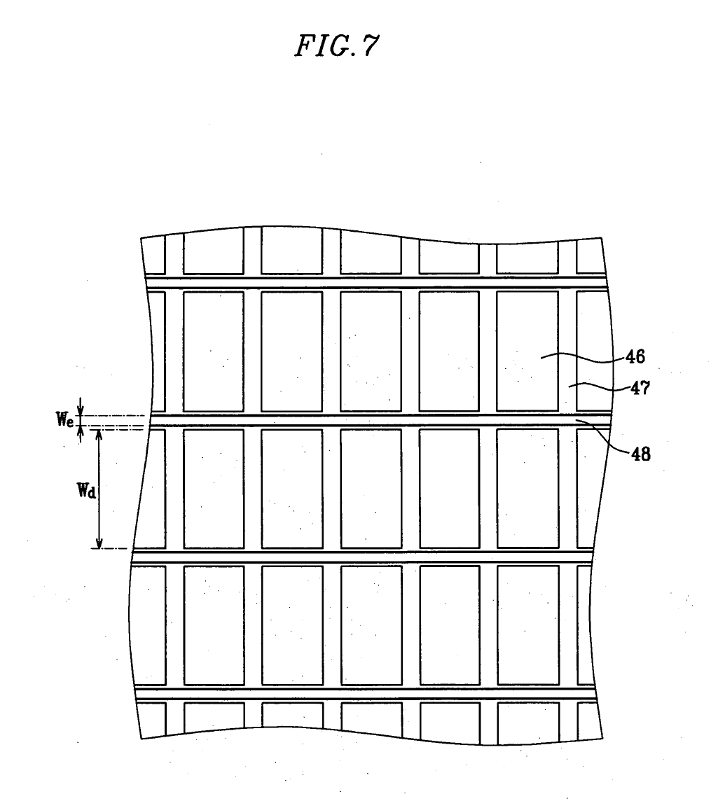

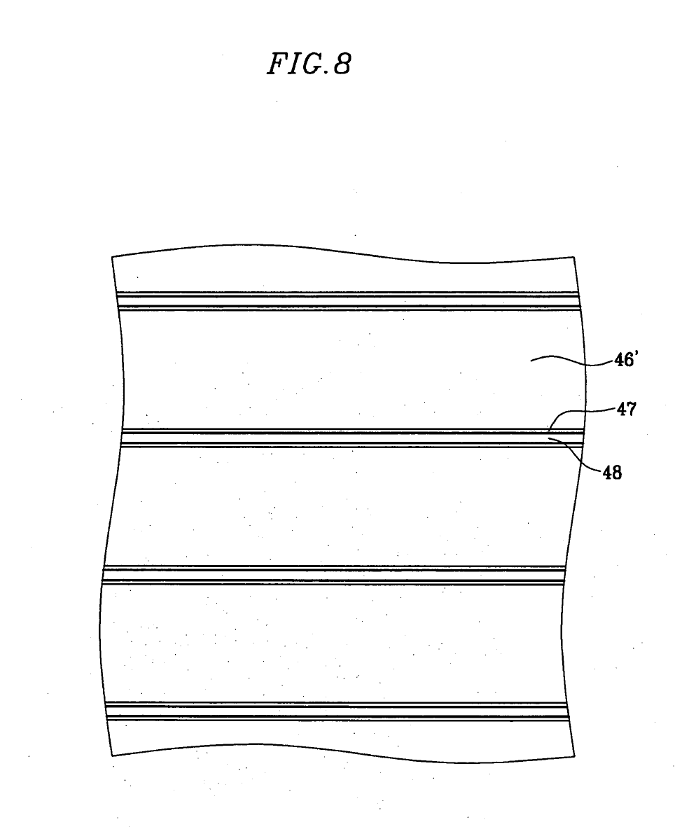

The recessed areas 46 for discharge space formation can be, as shown in FIG. 7, formed discontinuously to be a plurality of independent discharge spaces arranged in parallel. Alternatively, as shown in FIG. 8, recessed areas 46′ for discharge space formation can be formed as a continuous groove.

In a further embodiment, a width Wd of the recessed areas 46 for discharge space formation can be wider than a width We of the recessed areas 48 for electrode formation. The recessed areas 46 for discharge space formation can be deeper than the recessed areas 48 for electrode formation.

Next, the recessed areas 48 for electrode formation are filled with an electrode paste to form the second electrodes 50 and the third electrodes 51 (S16) (See FIG. 6E).

The electrode paste can be filled into the recessed areas 48 for electrode formation by a dispenser, and alternatively, can be formed in the recessed areas 48 for electrode formation by a pattern printing method. Silver (Ag) can be used as an electrode paste for filling the recessed areas 48 for electrode formation.

Compared to a conventional surface discharge PDP, the face discharge PDP requires the electrodes to be about ten times thicker. Also, since the electrodes are formed inside the dielectric layer, the electrodes do not oxidize during the firing process and remain attached to the dielectric material. Silver (Ag) paste is a paste with a non-oxidizable metallic powder. Therefore, silver (Ag) paste can be used for the present embodiment. The problems such as shrinkage of the electrodes and the oxidation of the electrodes during the firing process are solved at the same time by filling the recessed areas 48 for electrode formation with the silver (Ag) paste according to the manufacturing method of the present embodiment.

Furthermore, the recessed areas 46 for discharge space formation are formed by etching so that surface roughness of the dielectric layer serving as the discharge surface becomes smooth. That also improves the density and the uniformity of the MgO protective layer deposited on the discharge surface.

The second electrodes 50 and the third electrodes 51 respectively serve as scan electrodes and sustain electrodes. That is, the second electrodes 50 serve as scan electrodes when a scan pulse voltage is supplied to the second electrodes 50 during the address period, and the third electrodes 51 serve as sustain electrodes when a sustain pulse voltage is supplied to the third electrodes 51 during the discharge sustain period. Since the role of each electrode can be changed depending on the voltage supplied thereto, the second electrodes 50 can serve as sustain electrodes, and the third electrodes 51 can serve as scan electrodes.

Next, a third dielectric layer 52 is partially formed on the second dielectric layer 47 in order to cover the recessed area 48 for electrode formation filled with the electrode paste (S17)(See FIG. 6F).

The third dielectric layer 52 is preferably formed to cover the recessed area 48 for electrode formation in a manner that the third dielectric layer 52 is formed on the adjacent area only of the second dielectric layer 47 to the recessed area 48 for electrode formation. Such a third dielectric layer 52 can be formed by a pattern printing method.

The electrode paste in the recessed areas 48 for electrode formation and the dielectric layer 52 can be fired at the same time after forming the third dielectric layer 52.

Following the above processes, the PDP is completed by bonding the front substrate where the electrodes are formed to another substrate (the rear substrate) where the barrier ribs are formed and a phosphor layer is formed on the discharge cells defined by the barrier ribs. The discharge cells can be formed by etching the barrier rib material that is coated on the substrate (the rear substrate). The discharge cells can also be formed by etching the substrate (the rear substrate) itself.

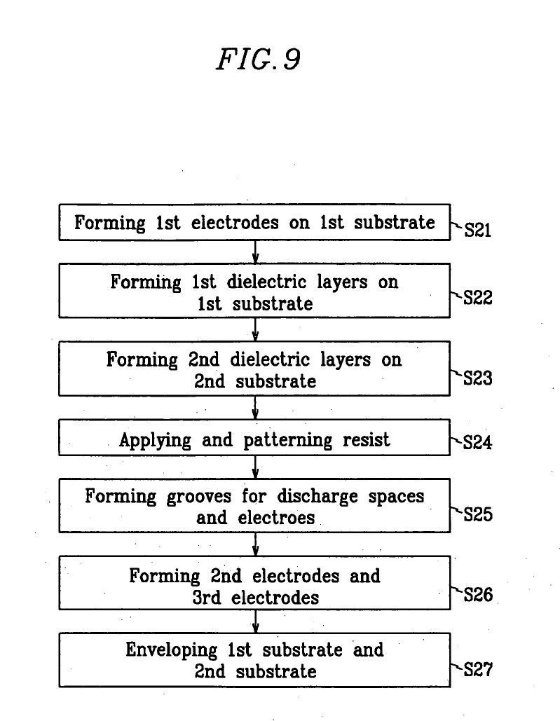

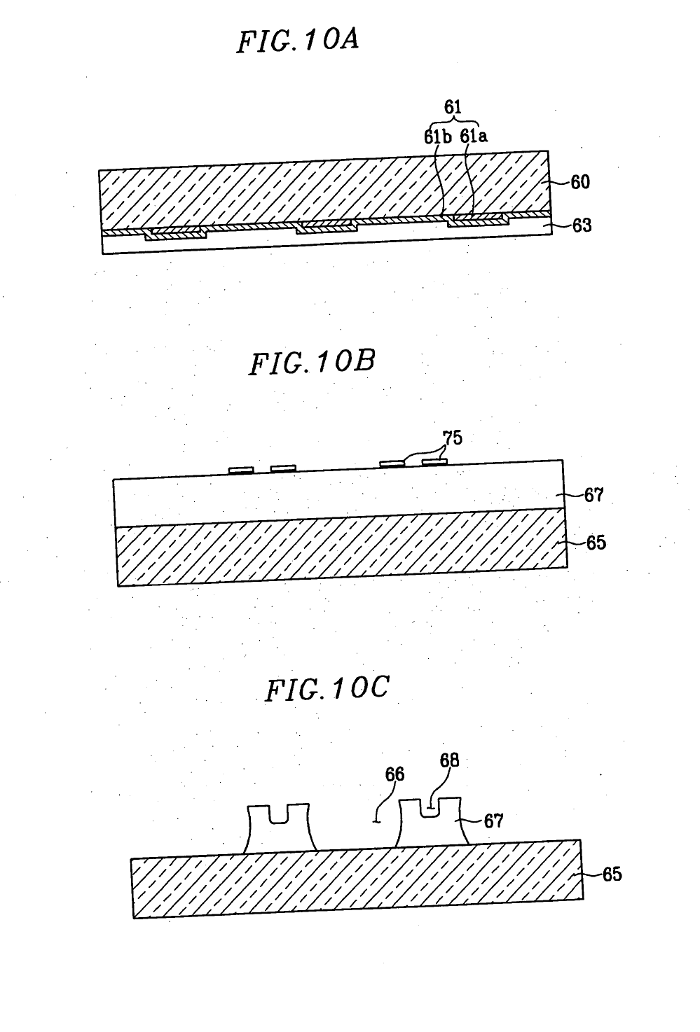

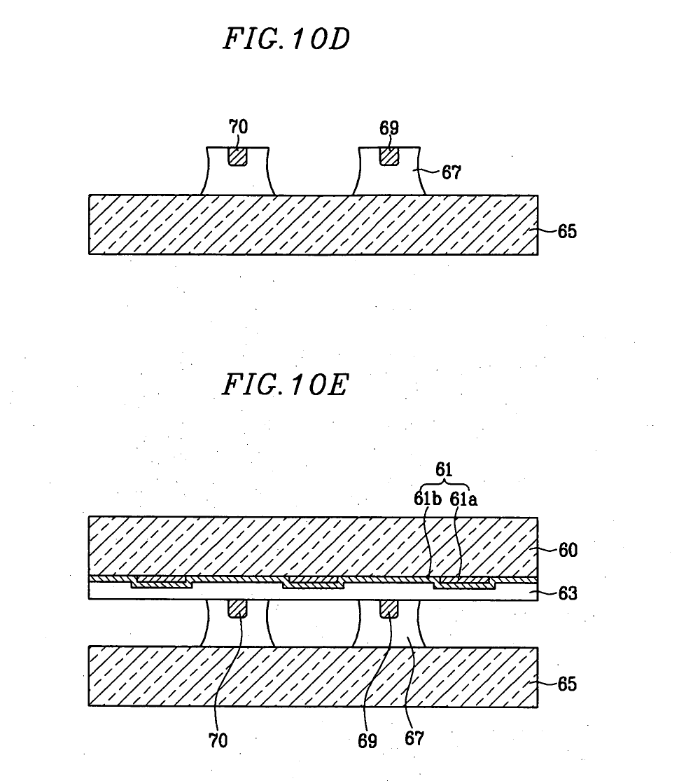

FIG. 9 is a flowchart of a method of manufacturing a PDP according to a second embodiment of the present invention. FIGS. 10A to 10E are cross-sectional views of the PDP according to the second embodiment of the present invention during the processes for its manufacture.

First, first electrodes 61 are formed on a substrate 60 (S21)(see FIG. 10A).

Each first electrode 61 includes a bus electrode 61b extending in a first direction and protrusion electrodes 61a extending in a second direction crossing the first direction. A plurality of the bus electrodes 61b of the first electrode 61 are formed in parallel to each other and can be made of metal. The protrusion electrodes 61a are preferably transparent electrodes, and can be made of Indium-Tin-Oxide (ITO), for example.

The first electrodes 61 formed accordingly serve as an address electrodes for selecting a discharge cell to be turned on when an address voltage is supplied thereto during the address period.

Then, a first dielectric layer 63 is formed on the substrate 60 to cover the first electrode 61 (S22) (See FIG. 10A).

The first dielectric layer 63 can be formed by drying/firing a dielectric paste that is coated by a screen printing method. As an alternative to the screen printing method, a dielectric sheet (green sheet) can be laminated by a laminator to the front substrate 60, or a dielectric paste can be coated by a coator.

Then, a second dielectric layer 67 is formed on a second substrate 65 (S23) (See FIG. 10B).

The second dielectric layer 67 can also be formed by drying/firing a dielectric paste that is coated by a screen printing method. As an alternative to the screen printing method, a dielectric sheet (green sheet) can be laminated by a laminator to the second substrate 65, or a dielectric paste can be coated by a coator.

The second dielectric layer 67 is formed to be thicker than the first dielectric layer 63. Since the second dielectric layer 67 is etched off to form recessed areas 68 for electrode formation and recessed areas 66 for discharge space formation, the second dielectric layer 67 is preferably formed thick enough for the space required for a discharge.

Next, a resist 75 is coated on top of the second dielectric layer 67, and the resist 75 is patterned (S24) (See FIG. 10B).

A photoresist or dry film resist can be used for the resist 75. Depending on an etching material, either the photoresist or the dry film resist is selected.

For patterning the resist 75, the resist 75 is covered by a photomask having a predetermined pattern, exposed to a light source (for example, ultraviolet rays), and then developed by a developing liquid. This process demarcates the region to be the recessed areas 68 for electrode formation and the region to be the recessed areas 66 for discharge space formation.

Next, the recessed areas 68 for electrode formation and the recessed areas 66 for discharge space formation are formed at the same time by etching the second dielectric layer 67 with the patterned resist 75 as a protective layer (S25) (See FIG. 10C).

More specifically, when an etchant is sprayed on top of the patterned resist 75, the exposed area of the second dielectric layer 67 through the patterned resist 75 is etched t to form the recessed areas, and an unexposed area remains intact to form the dielectric layer protecting a second electrode 69 and a third electrode 70.

The recessed areas 68 for electrode formation are formed extending in the direction crossing the extending direction of the first electrode 61, and are a continuous groove.

The recessed areas 66 for discharge space formation can be formed discontinuously to be a plurality of independent discharge spaces arranged in parallel, and alternatively recessed areas for discharge space formation can be a continuous groove.

In a further embodiment, the recessed areas 66 for discharge space formation are formed wider than the recessed areas 68 for electrode formation. The recessed areas 66 for discharge space formation are formed deeper than the recessed areas 68 for electrode formation.

Next, the recessed areas 68 for electrode formation are filled with an electrode paste to form the second electrodes 69 and the third electrodes 70 (S26) (See FIG. 10D).

The electrode paste can be filled into the recessed areas 68 for electrode formation by a dispenser, and alternatively, can be formed in the recessed areas 68 for electrode formation by a pattern printing method. Silver (Ag) paste can be used as the electrode paste for filling the recessed areas 68 for electrode formation.

The second electrodes 69 and the third electrodes 70 respectively serve as scan electrodes and sustain electrodes. That is, the second electrodes 69 serve as scan electrodes when a scan pulse voltage is supplied to the second electrodes 69 during the address period, and the third electrodes 70 serve as sustain electrodes when a sustain pulse voltage is supplied to the third electrodes 70 during the discharge sustain period. Since the role of each electrode can be changed depending on the voltage supplied thereto, the second electrodes 69 can serve as sustain electrodes, and the third electrodes 70 can serve as scan electrodes.

Finally, the first substrate 60 and the second substrate 65 are bonded to each other (S27) (See FIG. 10E).

In the bonding process where the first substrate 60 having the first electrodes 61 and the first dielectric layer 63 formed thereon is bonded to the second substrate 65 having the second electrodes 69, the third electrodes 70 and the second dielectric layer 67 formed thereon, the first dielectric layer 63 covers the recessed areas 68 for electrode formation filled by the second electrodes 69 and the third electrodes 70. Alternatively, the first substrate 60 can be bonded to the second substrate 65 where another dielectric layer is formed covering the recessed areas 68 for electrode formation filled by the second electrodes 69 and the third electrodes 70.

Although embodiments of the present invention have been described in detail hereinabove, it should be clearly understood that many variations and/or modifications of the basic inventive concepts taught herein will still fall within the spirit and scope of the present invention, as defined by the appended claims.

What is claimed is:

1. A method of manufacturing a Plasma Display Panel (PDP), comprising:
forming first electrodes on a substrate;
forming a first dielectric layer on the substrate to cover the first electrodes;
forming a second dielectric layer to cover the first dielectric layer;
coating a resist on the second dielectric layer;
patterning the resist;
etching the second dielectric layer with the patterned resist as a protective layer to form recessed areas for electrode formation and recessed areas for discharge space formation;
filling the recessed areas for electrode formation with an electrode paste to form second electrodes and third electrodes; and
forming a third dielectric layer on a portion of the second dielectric layer to cover the recessed areas for electrode formation filled with the electrode paste.

2. The method of manufacturing a PDP of claim 1, wherein the first electrodes each include a bus electrode formed to extend in a first direction and a protrusion electrode extending from the bus electrode in a second direction crossing the first direction.

3. The method of manufacturing a PDP of claim 1, wherein the second dielectric layer is formed to be thicker than the first dielectric layer.

4. The method of manufacturing a PDP of claim 1, wherein the first dielectric layer is formed of an etching-resistant dielectric material.

5. The method of manufacturing a PDP of claim 1, wherein the second dielectric layer is formed of an etchable dielectric material.

6. The method of manufacturing a PDP of claim 1, wherein the recessed areas for electrode formation are formed to extend in a direction crossing an extending direction of the first electrodes.

7. The method of manufacturing a PDP of claim 1, wherein forming the recessed areas for electrode formation and the recessed areas for discharge space formation comprises:
coating a resist on the second dielectric layer;
patterning the resist through exposure and development; and
spraying an etchant on the resist and on the second exposed dielectric layer to etch the second dielectric layer.

8. The method of manufacturing a PDP of claim 7, wherein coating the resist on the second dielectric layer comprises coating either a photoresist or a dry film resist.

9. The method of manufacturing a PDP of claim 1, wherein the recessed areas for discharge space formation are formed wider than the recessed areas for electrode formation.

10. The method of manufacturing a PDP of claim 1, wherein the recessed areas for discharge space formation are formed deeper than the recessed areas for electrode formation.

11. The method of manufacturing a PDP of claim 1, wherein the recessed areas for electrode formation are formed as a continuous groove.

12. The method of manufacturing a PDP of claim 1, wherein the recessed areas for discharge space formation are formed as a continuous groove.

13. The method of manufacturing a PDP of claim 1, wherein the recessed areas for discharge space formation are formed discontinuously to be a plurality of independent discharge spaces arranged in parallel.

14. The method of manufacturing a PDP of claim 1, wherein filling the recessed areas with the electrode paste comprises filling the recessed areas for electrode formation with a silver paste.

15. The method of manufacturing a PDP of claim 1, wherein filling the recessed areas for electrode formation with the electrode paste comprises filling the recessed areas for electrode formation with a dispenser.

16. The method of manufacturing a PDP of claim 1, wherein the electrode paste to fill the recessed areas for electrode formation is formed in the recessed areas for electrode formation by a pattern printing method.

17. The method of manufacturing a PDP of claim 1, wherein the third dielectric layer is formed by a pattern printing method.

18. The method of manufacturing a PDP of claim 1, further comprising firing the third dielectric layer after forming the third dielectric layer.

19. A method of manufacturing a Plasma Display Panel (PDP), comprising:
forming first electrodes on a first substrate;
forming a first dielectric layer on the first substrate to cover the first electrodes;
forming a second dielectric layer on a second substrate;
coating a resist on the second dielectric layer;
patterning the resist;
etching the second dielectric layer with the patterned resist as a protective layer to form recessed areas for electrode formation and recessed areas for discharge space formation;
filling the recessed areas for electrode formation with an electrode paste to form second electrodes and third electrodes; and
bonding the first substrate to the second substrate.

20. The method of manufacturing a PDP of claim 19, wherein the recessed areas for electrode formation are formed to extend in a direction crossing an extending direction of the first electrodes.

21. The method of manufacturing a PDP of claim 19, wherein the second dielectric layer is formed to be thicker than the first dielectric layer.

22. The method of manufacturing a PDP of claim 19, wherein forming the recessed areas for electrode formation and the recessed areas for discharge space formation comprises:
coating a resist on the second dielectric layer;
patterning the resist through exposure and development; and
spraying an etchant on the resist and the exposed second dielectric layer to etch the second dielectric layer.

23. The method of manufacturing a PDP of claim 22, wherein coating the resist on the second dielectric layer comprises coating either a photoresist or a dry film resist.

24. The method of manufacturing a PDP of claim 19, wherein the recessed areas for discharge space formation are formed wider than the recessed areas for electrode formation.

25. The method of manufacturing a PDP of claim 19, wherein the recessed areas for discharge space formation are formed depth than the recessed areas for electrode formation.

26. The method of manufacturing a PDP of claim 19, wherein the recessed areas for electrode formation are formed as a continuous groove.

27. The method of manufacturing a PDP of claim 19, wherein the recessed areas for discharge space formation are formed as a continuous groove.

28. The method of manufacturing a PDP of claim 19, wherein the recessed areas for discharge space formation are formed discontinuously to be a plurality of independent discharge spaces arranged in parallel.

29. The method of manufacturing a PDP of claim 19, wherein filling the recessed areas with the electrode paste comprises filling the recessed areas for electrode formation with a silver paste.

30. The method of manufacturing a PDP of claim 19, wherein filling the recessed areas for electrode formation with the electrode paste comprises filling the recessed areas for electrode formation with a dispenser.

31. The method of manufacturing a PDP of claim 19, wherein the electrode paste to fill the recessed areas for electrode formation is formed in the recessed areas for electrode formation by a pattern printing method.

32. A Plasma Display Panel (PDP), comprising:
a first substrate and a second substrate, the first and second substrates arranged to face each other;
a plurality of discharge cells defined in a space between the first and second substrates;
first electrodes arranged parallel to each other on the first substrate in a first direction;
second electrodes and third electrodes arranged on the first substrate in a second direction crossing the first direction, the second and third electrodes respectively corresponding to each of the discharge cells and spaced apart from the first electrodes;
a phosphor layer arranged inside each of the discharge cells; and
dielectric layers surrounding the second and third electrodes, the second and third electrodes protruding from the first substrate in a third direction toward the second substrate; and
wherein the second electrodes and the third electrodes are arranged to face each other with a discharge space therebetween, each discharge space having a maximum inner width at a position where the respective second electrode faces the respective third electrode.

33. The PDP of claim 32, further comprising curved discharge surfaces, the discharge surfaces on which the dielectric layer surrounding the second electrodes and the third electrodes being exposed to the discharge space.

34. The PDP of claim 32, further comprising a dielectric layer arranged to cover the first electrodes and to separate the first electrodes from the second electrodes and the third electrodes, the dielectric layer comprising an etching-resistant dielectric material.

35. The PDP of claim 32, further comprising a dielectric layer surrounding the second electrodes and the third electrodes, the dielectric layer comprising an etchable dielectric material.

36. The PDP of claim 32, wherein the second electrodes and the third electrodes are arranged over boundaries of the discharge cells to pass along the boundary thereof and alternately positioned.
